(19) United States
(12) Patent Application Publication
(10) Pub. No.: US 2007/0147928 A1
(43) Pub. Date: Jun. 28, 2007

(54) IMAGE FORMING SYSTEM, METHOD OF REALIZING SIMULATED PRINTING OPERATION, PROGRAM FOR IMPLEMENTING THE METHOD, AND STORAGE MEDIUM STORING THE PROGRAM

(75) Inventors: Masashi OYUMI, Abiko-shi (JP); Toshio HAYASHI, Toride-shi (JP); Akihiko SAKAI, Abiko-shi (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/608,442

(22) Filed: Dec. 8, 2006

(30) Foreign Application Priority Data
Dec. 27, 2005 (JP) 2005-376404

(51) Int. Cl. B41J 5/30

(52) U.S. Cl. 400/62

(57) ABSTRACT

An image forming system which is capable of realizing a highly accurate simulated printing operation thereby shortening a development schedule and reducing development costs. In the image forming system, a plurality of printer functional modules perform operations for printing. A plurality of printer drivers drive the printer functional modules, respectively. A system controller is connected to the printer drivers via a general-purpose bus to control the printer drivers. A bus I/F connects an external computer to the image forming system via the general-purpose bus. Printer control software constructs a printer control environment enabling control identical to the control by the system controller to be performed on the printer drivers, on the external computer, to thereby carry out printer control. Simulation software cooperates with the printer control software to simulatively realize printing operation.

### BACKGROUND OF THE INVENTION

1. Field of the Invention

The present invention relates to an image forming system, a method of realizing a simulated printing operation, a program for implementing the method, and a storage medium storing the program.

2. Description of the Related Art

Conventionally, some image forming apparatuses, such as digital copiers and digital printers, have a general-purpose bus provided for functional expansion (see e.g. Japanese Laid-Open Patent Publication (Kokai) No. H09-272244). In such an image forming apparatus, a control section and independently operating function modules are interconnected by the general-purpose bus, and the control section controls the function modules.

Further, in recent years, the image forming apparatus tends to have its system more and more complicated e.g. due to multifunctionalization of the apparatuses. In development of such an image forming apparatus having a complicated system, simulation is carried out, or an operation verifying hardware jig is constructed, so as to verify the operation of the image forming apparatus. For example, the simulation is performed by virtually operating printer driving software on an external computer based on virtually provided input/output conditions.

For the simulation, it is required to prepare a program for simulating the operation of hardware, i.e. to turn the hardware into software. However, with increase in complexity of the system, the amount of work required for turning the entire hardware into software is becoming excessively large, which makes it very difficult to realize all the functions of the system by software.

Further, when a designer of a product has to design software for the operation verifying hardware jig, the designer cannot proceed with work for designing of the actual product, and hence designing work for the product can be delayed.

### SUMMARY OF THE INVENTION

It is an object of the present invention to provide an image forming system, a method of realizing a simulated printing operation, and a program for implementing the method, which are capable of realizing highly accurate simulated printing operation, thereby shortening a development schedule and reducing development costs, and a storage medium storing the program.

To attain the above object, in a first aspect of the present invention, there is provided a image forming system comprising a plurality of operating units that perform operations for printing, a plurality of printer driver units that drive the operating units, respectively, a control unit connected to the printer driver units via a general-purpose bus interface to control the printer driver units, a connection unit that connects an external computer to the image forming system via the general-purpose bus interface, a printer control unit that constructs a printer control environment enabling control identical to the control by the control unit to be performed on the printer driver units, on the external computer, to thereby carry out printer control, and a simulated printing operation-realizing unit that cooperates with the printer control unit to simulatively realize a printing operation.

With the arrangement of the first aspect of the present invention, it is possible to realize highly accurate simulated printing operation to thereby shorten a development schedule and reduce development costs.

Preferably, the simulated printing operation-realizing unit comprises a simulation unit that simulates an operation obtained by controlling a printer driver unit virtually implemented as a means substituted for a specific one of the printer driver units in the constructed printer control environment, the simulated operation being associated with an operation obtained by controlling the specific one of the printer driver units, and a simulated operation-realizing unit that simulatively realizes a printing operation by combining the simulated operation and an operation obtained by controlling another one of the printer driver units different from the specific one in the constructed printer control environment.

With the arrangement of this preferred embodiment, in the printer control environment constructed on the external computer, operation of the printer driver unit virtualized as a means substituted for the specific one of a plurality of printer driver units and operation of the operating unit driven by the virtual printer driver unit are simulated, and a printing operation is simulatively realized by combining the simulated operations and operation obtained by controlling a printer driver unit different from the specific one. Therefore, it is possible to realize printing operation under the same hardware conditions as when an actual system is employed.

Preferably, the simulated printing operation-realizing unit comprises a substitutive control unit that performs substitutive control of a specific one of the printer driver units in place of control thereof performed in the constructed printer control environment, and a simulated operation-realizing unit that simulatively realizes a printing operation by combining an operation obtained by controlling the specific one of the printer driver units by the substitutive control and an operation obtained by controlling another one of the printer driver units different from the specific one in the constructed printer control environment.

With the arrangement of this preferred embodiment, the specific one of the printer driver units is performed is subjected to substitutive control by the substitutive control unit instead of being virtually controlled in a printer control environment constructed on the external computer, and printing operation is simulatively realized by combining operation obtained by controlling the specific printer driver unit by the substitutive control and operation obtained by controlling the printer driver unit different from the specific one in the constructed printer control environment. Therefore, it is possible to verify operations of the hardware as to whether the printer driver unit drives the associated operation unit under the same hardware conditions as when an actual system is employed.

Preferably, the simulated printing operation-realizing unit comprises a simulation unit that simulates an operation obtained by controlling a printer driver unit virtually implemented as a means substituted for a first one of the printer driver units in the constructed printer control environment, the simulated operation being associated with an operation obtained by controlling the first one of the printer driver units, a substitutive control unit that performs substitutive control of a second one of the printer driver units in place of control thereof performed in the constructed printer control environment, and a simulated operation-realizing unit that simulatively realizes a printing operation by combining the simulated operation, an operation obtained by controlling the second one of the printer driver units by the substitutive control, and an operation obtained by controlling another one of the printer driver units different from the first and second ones in the constructed printer control environment.

Preferably, the general-purpose bus interface is implemented by a PCI-EXPRESS bus.

To attain the above object, in a second aspect of the present invention, there is provided a method of realizing a simulated printing operation for an image forming system including a plurality of operating units that perform operations for printing, a plurality of printer driver units that drive the operating units, respectively, and a control unit connected to the printer driver units via a general-purpose bus interface to control the printer driver units, comprising a connection step of connecting an external computer to the image forming system via the general-purpose bus interface, a printer control step of constructing a printer control environment enabling control identical to the control by the control unit to be performed on the printer driver units, on the external computer, to thereby carry out printer control, and a simulated printing operation-realizing step of cooperating with the printer control step to simulatively realize a printing operation.

Preferably, the simulated printing operation-realizing step comprises a simulation step of simulating an operation obtained by controlling a printer driver unit virtually implemented as a means substituted for a specific one of the printer driver units in the constructed printer control environment, the simulated operation being associated with an operation obtained by controlling the specific one of the printer driver units, and a simulated operation-realizing step of simulatively realizing a printing operation by combining the simulated operation and an operation obtained by controlling another one of the printer driver units different from the specific one in the constructed printer control environment.

Preferably, the simulated printing operation-realizing step comprises a substitutive control step of performing substitutive control of a specific one of the printer driver units in place of control thereof performed in the constructed printer control environment, and a simulated operation-realizing step of simulatively realizing a printing operation by combining an operation obtained by controlling the specific one of the printer driver units by the substitutive control and an operation obtained by controlling another one of the printer driver units different from the specific one in the constructed printer control environment.

Preferably, the simulated printing operation-realizing step comprises a simulation step of simulating an operation obtained by controlling a printer driver unit virtually implemented as a means substituted for a first one of the printer driver units in the constructed printer control environment, the simulated operation being associated with an operation obtained by controlling the first one of the printer driver units, a substitutive control step of performing substitutive control of a second one of the printer driver units in place of control thereof performed in the constructed printer control environment, and a simulated operation-realizing step of simulatively realizing a printing operation by combining the simulated operation, an operation obtained by controlling the second one of the printer driver units by the substitutive control, and an operation obtained by controlling another one of printer driver units different from the first and second ones in the constructed printer control environment.

To attain the above object, in a third aspect of the present invention, there is provided a program for causing an external computer to execute a method of realizing a simulated printing operation for an image forming system including a plurality of operating units that perform operations for printing, a plurality of printer driver units that drive the operating units, respectively, and a control unit connected to the printer driver units via a general-purpose bus interface to control the printer driver units, the program comprising a connection module for connecting the external computer to the image forming system via the general-purpose bus interface, a printer control module for constructing a printer control environment enabling control identical to the control by the control unit to be performed on the printer driver units, on the external computer, to thereby carry out printer control, and a simulated printing operation-realizing module for cooperating with the printer control module to simulatively realize a printing operation.

Preferably, the simulated printing operation-realizing module comprises a simulation module for simulating an operation obtained by controlling a printer driver unit virtually implemented as a means substituted for a specific one of the printer driver units in the constructed printer control environment, the simulated operation being associated with an operation obtained by controlling the specific one of the printer driver units, and a simulated operation-realizing module for simulatively realizing a printing operation by combining the simulated operation and an operation obtained by controlling another one of the printer driver units different from the specific one in the constructed printer control environment.

Preferably, the simulated printing operation-realizing module comprises a substitutive control module for performing substitutive control of a specific one of the printer driver units in place of control thereof performed in the constructed printer control environment, and a simulated operation-realizing module for simulatively realizing a printing operation by combining an operation obtained by controlling the specific one of the printer driver units by the substitutive control and an operation obtained by controlling another one of the printer driver units different from the specific one in the constructed printer control environment.

Preferably, the simulated printing operation-realizing module comprises a simulation module for simulating an operation obtained by controlling a printer driver unit virtually implemented as a means substituted for a first one of the printer driver units in the constructed printer control environment, the simulated operation being associated with an operation obtained by controlling the first one of the printer driver units, a substitutive control module for performing substitutive control of a second one of the printer driver units in place of control thereof performed in the constructed printer control environment, and a simulated operation-realizing module for simulatively realizing a printing operation by combining the simulated operation, an operation obtained by controlling the second one of the printer driver units by the substitutive control, and an operation obtained by controlling another one of the printer driver units different from the first and second ones in the constructed printer control environment.

To attain the above object, in a third aspect of the present invention, there is provided a storing medium storing the program according to the third aspect of the present invention in a computer-readable manner.

The above and other objects, features, and advantages of the invention will become more apparent from the following detailed description taken in conjunction with the accompanying drawings.

### BRIEF DESCRIPTION OF THE DRAWINGS

FIG. 1 is a block diagram of an image forming system according to a first embodiment of the present invention;

FIG. 2 is a longitudinal cross-sectional view of essential parts of a printer appearing in FIG. 1;

FIG. 3 is a block diagram showing the internal construction of a printer driver appearing in FIG. 1;

FIG. 4 is a block diagram showing the internal construction of a system controller appearing in FIG. 1;

FIG. 5 is a block diagram showing the configuration of software in the system controller;

FIG. 6 is a perspective view showing an example of implementation of the system controller, a general-purpose bus, and the printer driver on printed circuit boards;

FIG. 7 is a block diagram showing the system configuration of the image forming system with the printer divided into two functional modules;

FIG. 8 is a perspective view showing an example of implementation of the system controller, the general-purpose bus, and printer drivers on printed circuit boards in the case where the printer is divided into the two functional modules;

FIG. 9 is a perspective view showing an example of implementation of the system controller, the general-purpose bus, and the two printer drivers in the case where the printer drivers are implemented on the same printed circuit board;

FIG. 10 is a block diagram useful in explaining how an operation verification environment is constructed in an environment where the printer driver and one of the printer functional modules are not present;

FIG. 11 is a block diagram showing the configuration of software within a PC appearing in FIG. 10;

FIG. 12A is a schematic longitudinal cross-sectional view of the printer divided into the two functional modules;

FIG. 12B is a view of a controlled object included in the printer functional module as a temperature adjustment control module appearing in FIG. 12A;

FIG. 13 is a longitudinal cross-sectional view showing details of the arrangement of a fixing device appearing in FIG. 12B;

FIG. 14 is a block diagram showing the configuration of software in a PC for simulatively realizing the printing operation of an image forming system according to a second embodiment of the present invention; and

FIG. 15 is a block diagram showing the configuration of software in a PC for simulatively realizing printing operation by combining operation of an actual devise, operation of a virtual device, and operation of jig software.

### DETAILED DESCRIPTION OF THE PREFERRED EMBODIMENTS

The present invention will now be described in detail with reference to the drawings showing preferred embodiments thereof. It should be noted that the relative arrangement of the components, the numerical expressions and numerical values set forth in this embodiment do not limit the scope of the present invention unless it is specifically stated otherwise.

First, a description will be given of a first embodiment of the present invention.

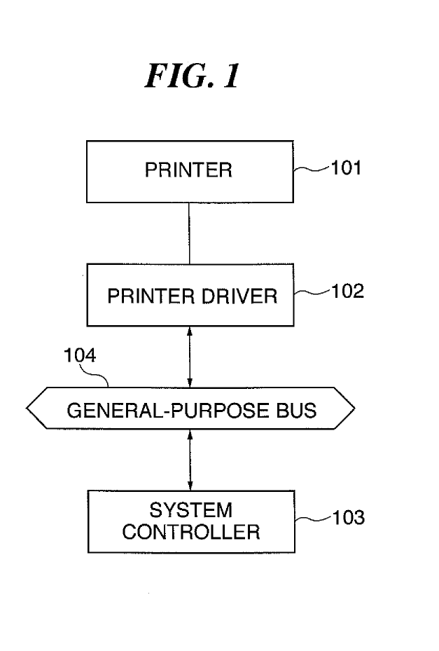

FIG. 1 is a block diagram of an image forming system according to the first embodiment.

As shown in FIG. 1, the image forming system according to the present embodiment is comprised of a printer 101 that performs printing operation, a printer driver 102 that drives the printer 101, and a system controller 103 that controls the overall operation of the system. The printer driver 102 and the system controller 103 are connected to each other via a general-purpose bus 104. The printer driver 102 is comprised of a plurality of modules, as described hereinafter, each of which drives an associated operation block in the printer 101.

In the image forming system according to the present embodiment, the system controller 103 controls the printer driver 102 via the general-purpose bus 104 to thereby execute a printing process. Further, by connecting the printer driver 102 to an external computer, not shown, via the general-purpose bus 104, it is possible to perform simulations of the operation of the printer driver 102. This will be described in detail hereinafter.

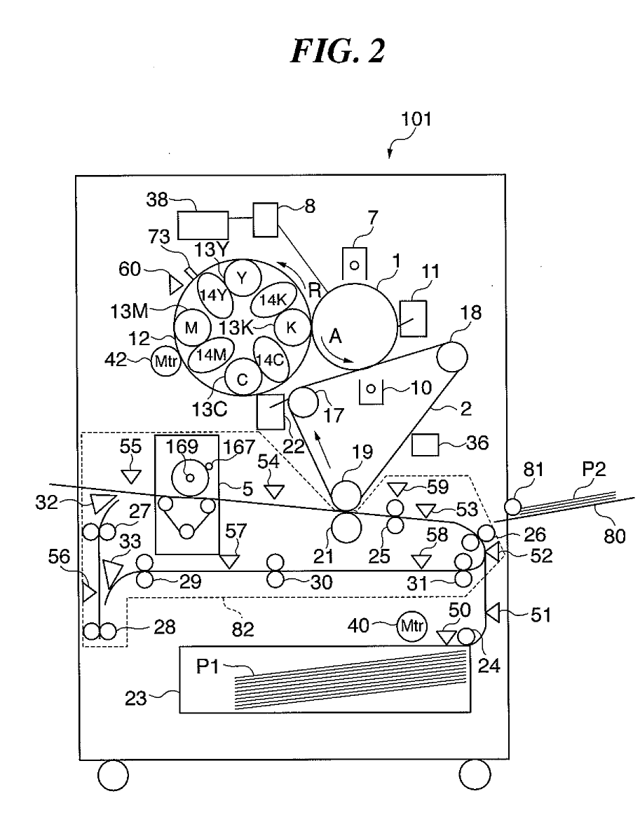

Next, the arrangement of the printer 101 will be described with reference to FIG. 2. FIG. 2 is a longitudinal cross-sectional view of essential parts of the printer 101 appearing in FIG. 1.

As shown in FIG. 2, the printer 101 is implemented by a full-color printer. The printer 101 includes an exposure device 8 that modulates a laser beam based on an image signal generated by an image controller 38, and irradiates a photosensitive drum 1 with the laser beam while scanning the laser beam.

The photosensitive drum 1 is rotated in a direction indicated by an arrow A. A primary electrostatic charger 7, a rotary developing body 12, and a drum cleaner 11 are arranged around the photosensitive drum 1. The primary electrostatic charger 7 uniformly charges the surface of the photosensitive drum 1 to a predetermined potential. The rotary developing body 12 includes a plurality of developing devices 13Y, 13M, 13C, and 13K and a plurality of toner bottles 14Y, 14M, 14C, and 14K. The developing devices 13Y, 13M, 13C, and 13K supply yellow toner, magenta toner, cyan toner, and black toner, respectively, and the toner bottles 14Y, 14M, 14C, and 14K contain yellow toner, magenta toner, cyan toner, and black toner, respectively. The rotary developing body 12 is rotated by a motor 42 in a direction indicated by an arrow R, whereby an associated one of the developing devices 13Y, 13M, 13C, and 13K is brought to a position for supplying toner to the photosensitive drum 1. Attached to the rotary developing body 12 is a position sensor flag 73, which is detected by a rotary developing body home position sensor (hereinafter referred to as the HP sensor) 60. The rotational position of the rotary developing body 12 is controlled based on the detection of the position sensor flag 73 by the HP sensor 60.

The surface of the photosensitive drum 1 is uniformly charged by the primary electrostatic charger 7, whereafter the photosensitive drum 1 is irradiated with the laser beam emitted from the exposure device 8, whereby an electrostatic latent image is formed on the surface of the photosensitive drum 1. The electrostatic latent image formed on the surface of the photosensitive drum 1 is visualized as a toner image by color toner supplied from one of the developing devices 13Y, 13M, 13C, and 13K. The visualized image is transferred onto an intermediate transfer belt 2 by a primary transfer device 10 (primary transfer). After completion of the primary transfer, residual toner remaining on the surface of the photosensitive drum 1 is scraped off and collected by a drum cleaner 11

A sequence of processes including exposure of the surface of the photosensitive drum 1 (electrostatic charging by the primary electrostatic charger 7, laser beam irradiation, and electrostatic latent image formation), development, primary transfer, and cleaning of the surface of the photosensitive drum 1 are performed for the Y (yellow) color, the M (magenta) color, the C (cyan) color, and the K (black) color, on a color-by-color basis.

Toner images in the respective colors are transferred onto the intermediate transfer belt 2 in superimposed relation, whereby a full-color toner image is formed on the intermediate transfer belt 2. The intermediate transfer belt 2 is wound around rollers 17, 18, and 19 to be rotated in a direction indicated by an arrow in FIG. 2. Between the rollers 18 and 19, there is disposed a belt reference position-detecting sensor 36 implemented by a reflective optical sensor, for detecting a reference mark position provided on the intermediate transfer belt 2. A signal from the belt reference position-detecting sensor 36 is used for accurately positioning toner images in the respective colors on the intermediate transfer belt 2 in superimposed relation.

The full-color toner image formed on the intermediate transfer belt 2 is transferred by a secondary transfer roller 21 onto a sheet P fed from a cassette 23 or a manual feed tray 80 via a registration roller pair 25 (secondary transfer). The sheet P having the full-color toner image transferred thereon is conveyed to a fixing device 5. The fixing device 5 heats and presses the sheet P to thereby fix the full-color toner image on the same. In the fixing device 5, a heater 169 is controlled based on temperature data detected by a thermistor 167, whereby fixing temperature control is performed.

The sheet P having the full-color toner image fixed thereon is discharged from the apparatus or conveyed to a double-sided conveying path according to switching operation of a flapper 32. In the case where the sheet P is to be conveyed to the double-sided conveying path, the sheet P is guided toward a conveying roller pair 27 by the flapper 32, and then conveyed by a conveying roller pair 28 until the trailing end of the sheet P passes the position of a flapper 33. Thereafter, the conveying roller pair 28 is reversely rotated, whereby the sheet P is guided toward a conveying roller pair 29 by the flapper 33. Thus, the sheet P is inverted upside down i.e. turned over. Then, the sheet P is conveyed to the registration roller pair 25 via the conveying roller pairs 29, and conveying roller pairs 30, 31, and 26. By thus guiding the sheet P into the double-sided conveying path, it is possible to form an image on the reverse side of the inverted sheet P. In short, images can be formed on the respective sides of the sheet P.

The cassette 23 contains a plurality of sheets P, and the sheets P are fed one by one from the cassette 23 by a pickup roller 24. The pickup roller 24 is driven by a motor 40. Each sheet P fed from the cassette 23 is conveyed to the registration roller pair 25 by the conveying roller pair 26. The leading end of the sheet P is brought into abutment with the registration roller pair 25, whereby conveyance of the sheet P is temporarily stopped. Thus, skew of the sheet P is corrected. Then, the sheet P is conveyed to the secondary transfer position by the registration roller pair 25 in predetermined timing.

A sheet P to be fed can also be placed on the manual feed tray 80. This sheet P is fed by a pickup roller 81 toward the registration roller pair 25.

In a conveying system 82 for conveying a sheet P thus fed from the cassette 23 or the manual feed tray 80 such that the sheet P is guided out of the apparatus or into the double-sided conveying path, there are provided a plurality of sheet detecting sensors 52 to 58 and a sheet thickness detecting sensor 59. Further, a sheet detecting sensor 51 is disposed in the vicinity of an outlet port of the cassette 23, and a sheet detecting sensor 50 is also provided for detecting presence of sheets P in the cassette 23.

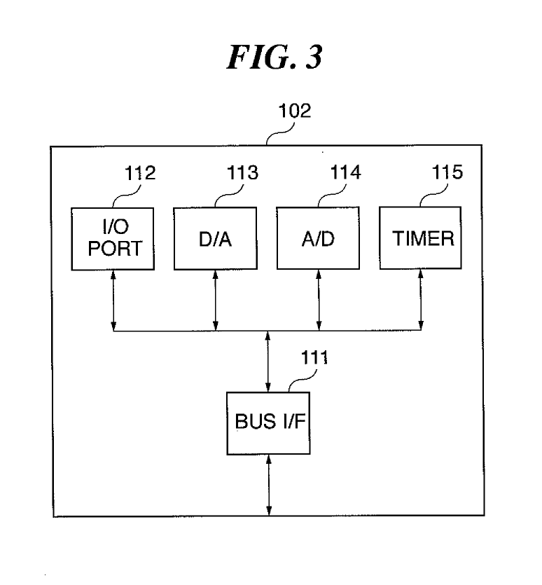

Next, the internal construction of the printer driver 102 will be described with reference to FIG. 3. FIG. 3 is a block diagram showing the internal construction of the printer driver 102 appearing in FIG. 1.

As shown in FIG. 3, the printer driver 102 has a bus I/F (bus interface) 111 connected to the general-purpose bus 104. Connected to the bus I/F 111 are an I/O port 112, a D/A converter 113, an A/D converter 114, and a timer 115. In FIG. 3, the I/O port 112, the D/A converter 113, the A/D converter 114, and the timer 115 are shown as individual functional blocks. In an actual hardware configuration, however, they may be provided as individual functional blocks, or may be provided as an integrated ASIC.

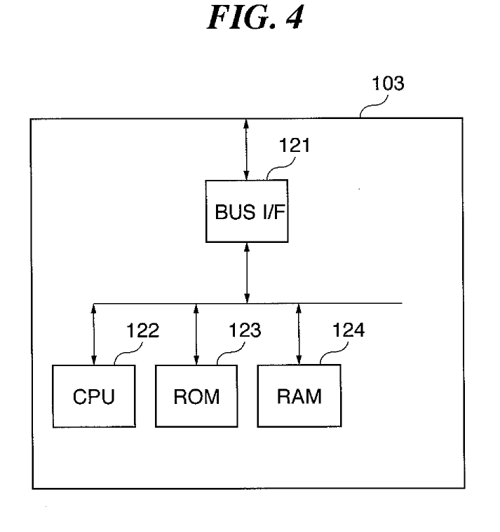

Next, the internal construction of the system controller 103 will be described with reference to FIG. 4. FIG. 4 is a block diagram showing the internal construction of the system controller 103 appearing in FIG. 1.

As shown in FIG. 4, the system controller 103 has a bus I/F (bus interface) 121 connected to the general-purpose bus 104. Connected to the bus I/F 121 are a CPU 122, a ROM 123 storing programs, and a RAM 124 providing a work area for the CPU 122. Further, not only the CPU 122, the ROM 123, and the RAM 124, but also other functional blocks and hardware required for control may also be connected to the bus I/F 121.

In the present embodiment, the general-purpose bus 104 is implemented by a PCI-EXPRESS bus generally used in PCs (personal computers). The PCI-EXPRESS bus is a serial bus capable of high-speed transmission, and has a transmission rate of 500 Mbyte/sec per lane. Further, the PCI-EXPRESS bus is capable of transferring data at a further increased transmission rate by operating a plurality of lanes, or 32 lanes at the maximum, in parallel. An I/F to the PCI-EXPRESS bus an actual system is put into practical use in the form of a one-lane connector or a connector having a plurality of lanes arranged in parallel.

The printer driver 102 is controlled by the system controller 103 as described above. The system controller 103 controls the printer driver 102, with a CPU bus associated with the printer driver 102 kept open to the general-purpose bus 104. The printer driver 102 is configured to have hardware configuration according to load control specific to the printer 101 except the bus I/F 111. On the other hand, the system controller 103 can be configured to have hardware configuration irrespective of the load specific to the printer 101.

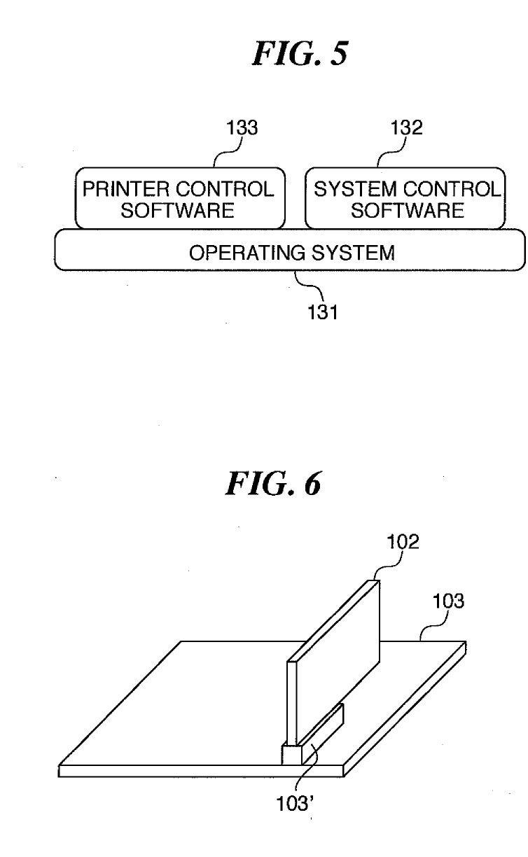

Next, the software configuration of the system controller 103 will be described with reference to FIG. 5. FIG. 5 is a block diagram showing the configuration of software in the system controller 103.

As shown in FIG. 5, in the system controller 103, an operating system (OS) 131 operates, and system control software 132 and printer control software 133 operate on the OS 131. The printer control software 133 cooperates with the system control software 132 operating in parallel on the OS 131, to control the printer driver 102. The printer driver 102 is controlled via the bus I/F 121, the general-purpose bus 104, and the bus I/F 111. The printer driver 102 operates the functional blocks incorporated therein, in response to a bus signal based on a command from the printer control software 133. The functional blocks respectively drive loads on the printer 101. Thus, the printer 101 carries out a printing operation based on the command from the printer control software 133.

FIG. 6 is a perspective view showing an example of implementation of the system controller 103, the general-purpose bus 104, and the printer driver 102 on printed circuit boards. The system controller 103 is implemented on a printed circuit board having the CPU 122 and the other components mounted thereon. The printer driver 102 is also implemented on a printed circuit board. A board-to-board connector 103′ connects between the system controller 103 and the general-purpose bus 104.

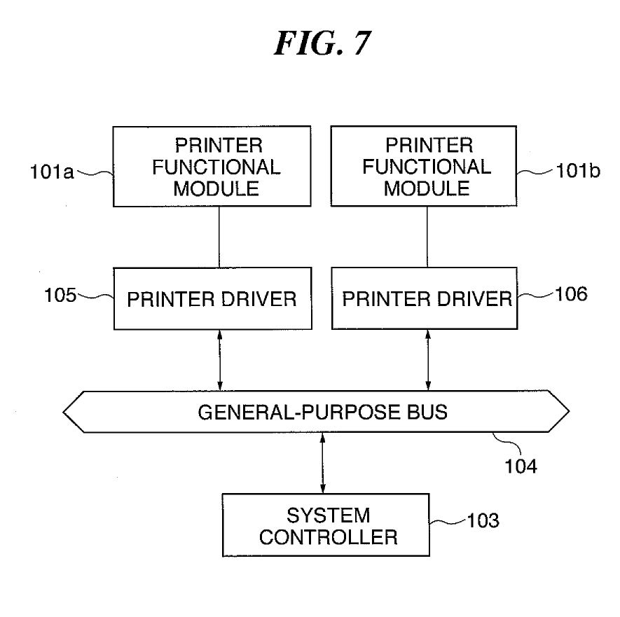

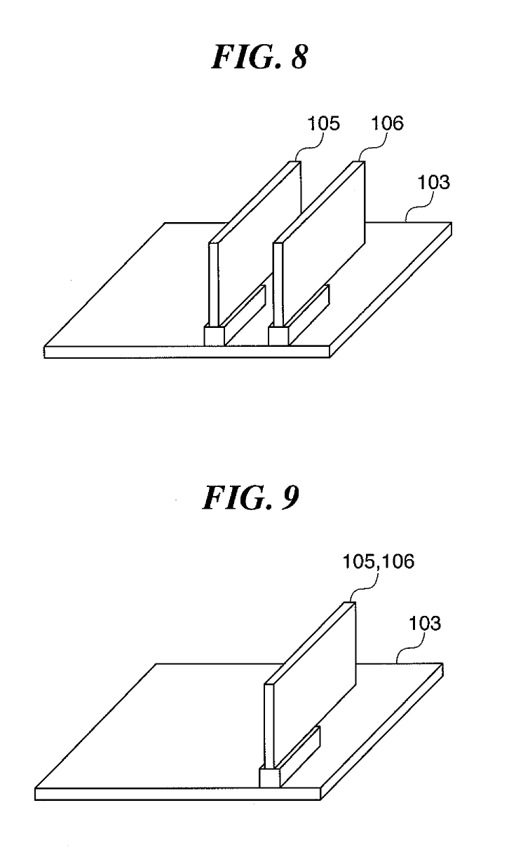

Next, a system configuration in a printer operating mode in the case where the printer 101 is divided into two functional modules will be described with reference to FIGS. 7 to 9. FIG. 7 is a block diagram showing the system configuration of the image forming system with the printer 101 divided into the two functional modules. FIG. 8 is a perspective view showing an example of implementation of the system controller 103, the general-purpose bus 104, and printer drivers 105 and 106 on printed circuit boards in the case where the printer 101 is divided into the two functional modules. FIG. 9 is a perspective view showing an example of implementation of the system controller 103, the general-purpose bus 104, and two printer drivers in the case where the printer drivers 105 and 106 are implemented on the same printed circuit board.

As shown in FIG. 7, the printer 101 is divided into two printer functional modules 101a and 101b according to functions. The printer functional module 101a is driven by the printer driver 105, and the printer functional module 101b is driven by the printer driver 106. The printer drivers 105 and 106 are controlled by the system controller 103 via the general-purpose bus 104.

When the printer 101 is thus divided, the printer drivers 105 and 106 may be implemented on two different printed circuit boards, respectively, or on the same printed circuit board.

In the former case, as shown in FIG. 8, the system controller 103 and the printer driver 105 are connected to each other via a board-to-board connector corresponding to one lane as a one form of connection by the PCI-EXPRESS bus forming the general-purpose bus 104. Similarly, the system controller 103 and the printer driver 106 are connected to each other via a board-to-board connector corresponding to one lane.

In the latter case, as shown in FIG. 9, a printed circuit board having the printer drivers 105 and 106 implemented thereon and the system controller 103 are connected to each other via a board-to-board connector corresponding to two lanes as another form of connection by the PCI-EXPRESS bus forming the general-purpose bus 104.

As described above, when the printer drivers 105 and 106 are provided separately, it is possible to employ the form of connection by one PCI-EXPRESS bus lane. Therefore, in the case of newly developing only some of the functional modules of a printer, only a portion involved in the driving of the functional modules to be developed can be separated as a different printed circuit board for the development.

In the development of an image forming system which is performed with some functional modules separated, employment of the above-described connection form makes it possible to combine existing portions of hardware and software with portions developed anew of those, to thereby construct an environment for verifying operation of the portions developed anew.

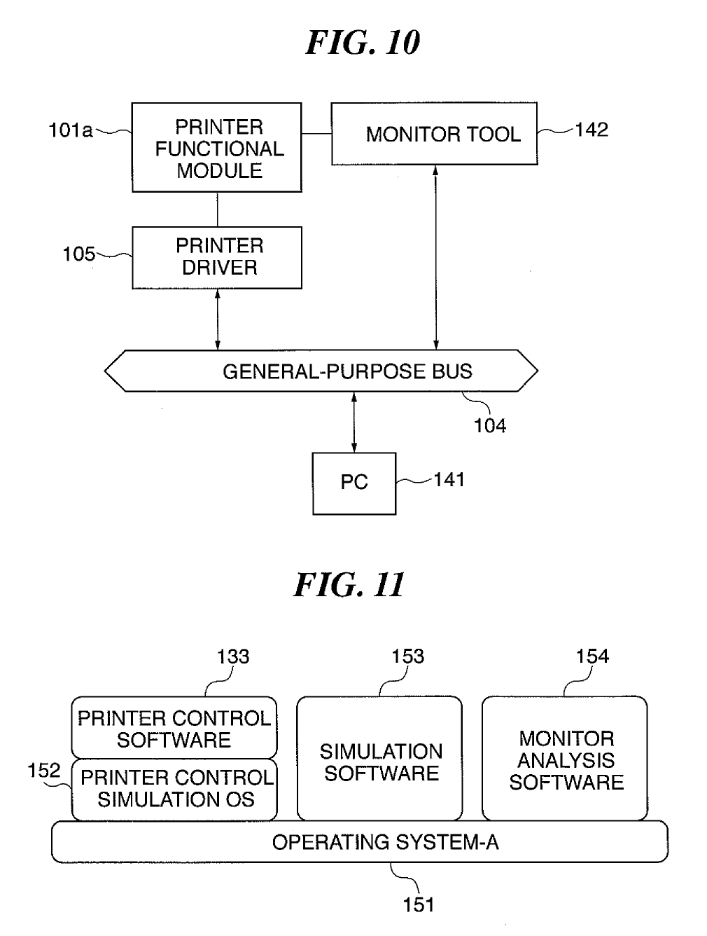

In new development of the printer driver 106 and the printer functional module 101b, the printer driver 106 and the printer functional module 101b are virtually implemented, i.e. assumed to be present though they are actually not. Then, printer operation is simulatively realized so as to verify a printer operation involving the virtual printer driver 106 and printer functional module 101b. This simulation will be described with reference to FIGS. 10 and 11. FIG. 10 is a block diagram useful in explaining how an operation verification environment is constructed in an environment where the printer driver 106 and the printer functional module 101b are not present. FIG. 11 is a block diagram showing the configuration of software within a PC appearing in FIG. 10.

In the case of simulatively realizing printer operation involving the virtual printer driver 106 and printer functional module 101b, an external computer (PC) 141 is connected to the general-purpose bus 104 as shown in FIG. 10. Connected to the general-purpose bus 104 is the printer driver 106. Further, connected to the general-purpose bus 104 is a monitor tool 142, which monitors the operating state of the printer functional module 101a driven by the printer driver 105. The details monitored by the monitor tool 142 are sent to the PC 141 via the general-purpose bus 104. At this time, the printer driver 106 and the printer functional module 101b to be driven by the printer driver 106 are not present, and hence they are constructed as virtual devices by simulation software operating on the PC 141. Then, printer operation is simulatively realized using the printer driver 105 and the printer functional module 101a each actually present and the printer driver 106 and printer functional module 101b constructed as virtual devices.

In the PC 141, as shown in FIG. 11, an operating system-A (OS-A) 151 operates, and a printer control simulation operating system (printer control simulation OS) 152 operates on the OS-A 151. This printer control simulation OS 152 is originally an OS required for operating printer control software 133 on the OS 131 of the system controller 103. Simulation software 153 and monitor analysis software 154 also operate on the OS-A 151.

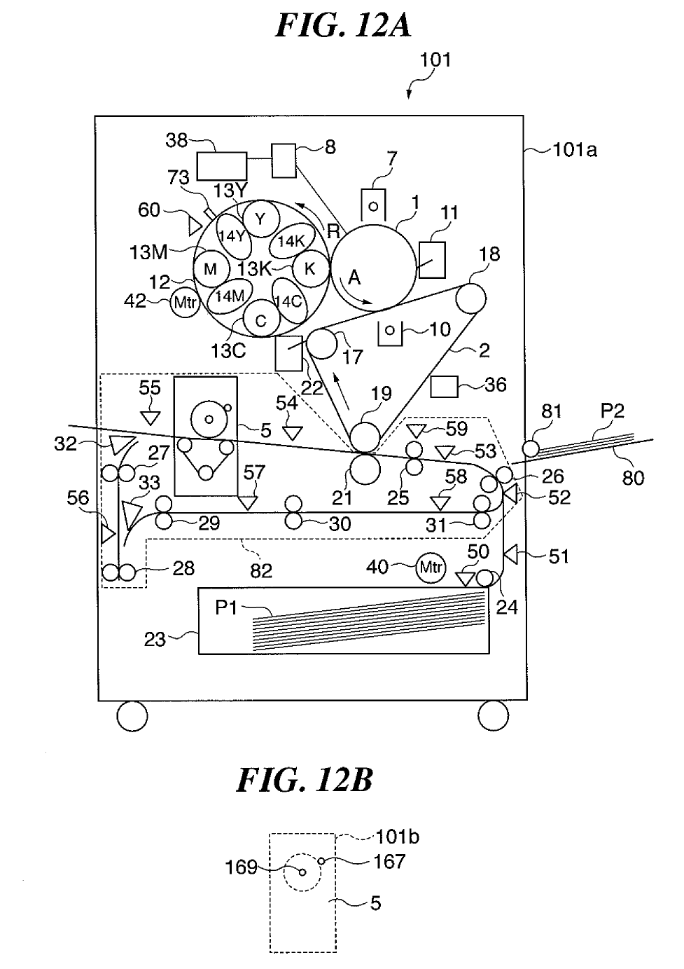

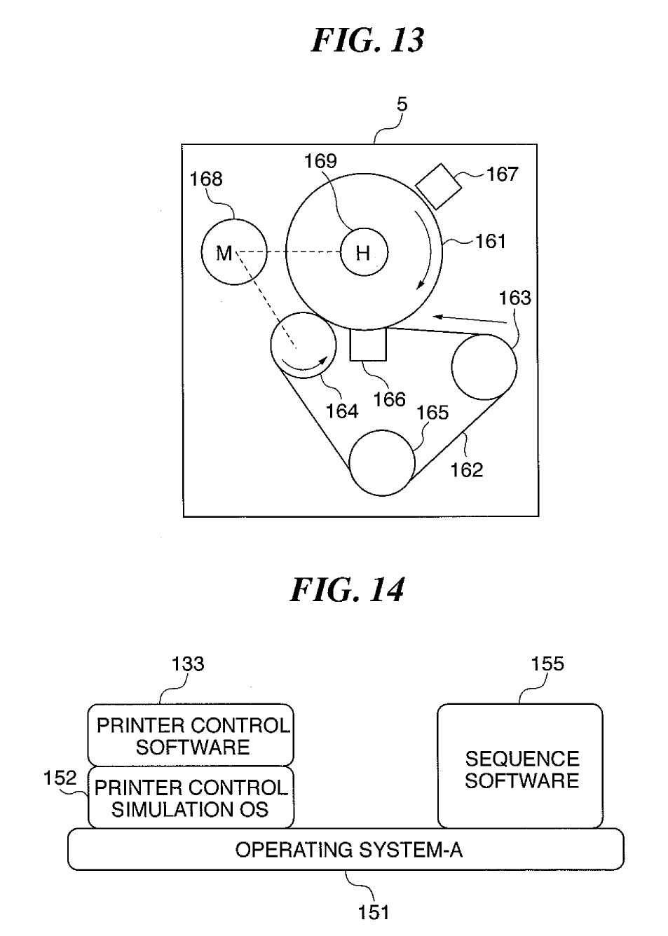

Next, a case where the printer 101 is divided into the fixing device 5 and a portion other than the fixing device 5, for newly developing a fixing device will be described with reference to FIGS. 12 and 13. FIG. 12A is a schematic longitudinal cross-sectional view of the printer 101 divided into the two functional modules. FIG. 12B is a view of a controlled object included in the printer functional module 101b as a temperature adjustment control module appearing in FIG. 12A. FIG. 13 is a longitudinal cross-sectional view showing details of the arrangement of the fixing device 5 appearing in FIG. 12B.

In the example, illustrated in FIG. 12A, the printer functional module 101b corresponds to the temperature adjustment control module in the fixing device 51 and the printer functional module 101a corresponds to the whole printer 101 except the temperature adjustment control module in the fixing device 5. As shown in FIG. 12B, the temperature adjustment control module in the fixing device 5 includes the heater 169 and the thermistor 167 as controlled objects.

The fixing device 5 is comprised of a fixing roller 161 and a fixing belt 162 as shown in detail in FIG. 13. The fixing belt 162 is wound around a plurality of rollers 163, 164, and 165. A pressure pad 166 is disposed at a location opposed to the fixing roller 161. A portion of the fixing belt 162 opposed to the fixing roller 161 is pressed by the pressure pad 166, for being brought into contact with the fixing roller 161. The fixing roller 161 is rotated by a motor 168 in a direction indicated by an associated arrow in FIG. 13. Further, the motor 168 drives the roller 164 for rotation in a direction indicated by an associated arrow in FIG. 13, whereby the fixing belt 162 is rotated in a direction indicated by an arrow in the figure.

The fixing roller 161 incorporates the heater 169 for heating a surface thereof, and the surface temperature of the fixing roller 161 is detected by the thermistor 167. The heater 169 is drivingly controlled based on the surface temperature of the fixing roller 161 detected by the thermistor 167, whereby temperature adjustment control is performed for maintaining the surface temperature of the fixing roller 161 at a predetermined temperature.

The fixing device 5 constructed as above has a nip formed between the fixing roller 161 and the fixing belt 162 so as to convey a sheet while sandwiching the same between the fixing roller 161 and the fixing belt 162. The sheet is heated and pressed while passing through the nip. This heats a toner image on the sheet and fixes the same.

Now, let it be assumed that the heater 169 was implemented by a halogen heater, and it is required to newly develop temperature adjustment control by power control for an IH heater (induction heating heater) to be introduced in place of the halogen heater. A fixing device having the IH heater is to be newly developed in terms of hardware. Therefore, in an environment where the fixing device having the IH heater is not present as hardware, it is required to virtually construct the fixing device having the IH heater so as to proceed with development and verification of new printer control software.

The controlled object in the fixing device having the IH heater is a temperature adjustment control module, and hence the temperature adjustment control module is virtually constructed by the simulation software 153 operating on the PC 141. More specifically, a supplied power control value for controlling electric power to be supplied to the IH heater, the sheet type of a sheet to be passed through the fixing device, a mode for copying, and so forth are input to the virtually constructed temperature adjustment control module, and a fixing temperature is calculated based on these inputs.

The printer control software 133 controls the printer functional module 101a via the printer driver 105 as an actual device, and at the same time exchanges data with the temperature adjustment control module of the fixing device virtually constructed on the simulation software 153, to thereby control printer operation.

The monitor tool 142 monitors electric power supplied to an AC input section of the printer functional module 101a. The monitor tool 142 measures voltage and electric current supplied to an AC input section of the printer functional module 101a to thereby calculate the value of electric power currently used by the printer functional module 101a on a real-time basis. The calculated value of electric power is input to the monitor analysis software 154 operating on the PC 141 via the general-purpose bus 104. The monitor analysis software 154 carries out data processing for converting the input value of electric power into data interpretable by the printer control software 133.

For example, when the supplied power control value for controlling electric power to be supplied to the IH heater is determined by the printer control software 133 based on the fixing temperature, an operation mode, and operation timing, the simulation software 153 calculates electric power consumed by the IH heater, based on the supplied power control value. Then, the calculated value of electric power currently used by the printer functional module 101a and the calculated power consumed by the heater are added up, and the total value is calculated on a real-time basis. When this calculated total value exceeds a predetermined value, an alarm indicating the fact is output.

As described above, the existing hardware and software except the temperature adjustment control module of the fixing device to be developed anew can be utilized without any change. Consequently, insofar as turning of hardware into software, which is required for simulation, is concerned, it suffices to realize only the temperature adjustment control module to be developed anew, by software. Further, the software of the temperature adjustment control module to be developed anew can also be simulated using the same software as will be incorporated in the printer control software 133 in the future.

The simulation software 153 can also be implemented by widely used simulation software. Similarly, the monitor analysis software 154 can be implemented by widely used monitor analysis software.

As described above, printing operation is simulatively realized by combining operation of a virtual device obtained in a printer control environment constructed on the PC 141 by the printer control software 133, which is the same printer control environment in which the system controller 103 operates, with operation of an actual device. This makes it possible to realize a highly accurate simulated printing operation, thereby shortening a development schedule and reducing development costs. Further, realization of a printing operation under the same hardware conditions as those of the actual system is made possible.

Although in the present embodiment, it is assumed that the printer functional module 101b is the temperature adjustment control module of the fixing device to be developed anew, and simulation is performed by combining the operation of the temperature adjustment control module with operations of other existing functional modules, this is not limitative. In short, a virtualized module only has to correspond to a module for controlling the printer 101, and the function thereof is not specifically limited.

Next, a second embodiment of the present invention will be described with reference to FIG. 14. FIG. 14 is a block diagram showing the configuration of software in a PC for simulatively realizing the printing operation of an image forming system according to the second embodiment.

The image forming system according to the present embodiment is identical in configuration to the image forming system according to the first embodiment. More specifically, in the system configuration of the present embodiment, as in the system configuration shown in FIG. 7, the printer 101 is divided into the two printer functional modules 101a and 101b, and printer operation is realized by controlling the printer functional modules 101a and 101b. The printer 101 has the same construction as shown in FIG. 2. The software configuration of the system controller 103 is identical to that shown in FIG. 5. Further, the printer functional module 101b corresponds to the temperature adjustment control module of the fixing device 5, and the printer functional module 101a corresponds to the other control modules of the printer 101 than the temperature adjustment control module of the fixing device 5. Details of the construction of the fixing device 5 are identical to those shown in FIG. 13.

In the present embodiment, the printer driver 106 for driving the printer functional module 101b is controlled by sequence software 155 operating on the PC 141 connected to the printer drivers 105 and 106 and the system controller 103 via the general-purpose bus 104. This control is performed in the case of verifying the hardware of the printer driver 106 in a development stage before completion of the control part of the printer driver 106 in the printer control software 133.

Specifically, as shown in FIG. 14, the OS-A 151 operates on the PC 141, and the printer control simulation OS 152 and the sequence software 155 operate on the OS-A 151. Further, the printer control software 133 operates on the printer control simulation OS 152. The sequence software 155 can be implemented by software widely used as jig software.

The above-described configuration makes it possible to cause the sequence software 155 to substitute for control of the temperature adjustment control module of the fixing device 5 while controlling a printing operation by the printer control software 133. This simulatively realizes a printing operation in which a sheet is actually passed through the fixing device 5 and an image is fixed on the sheet at a desired fixing temperature, even in a state where preparation of software has not been progressed. In short, operation of the temperature adjustment control module of the fixing device 5 close to actual operation is obtained, which makes it possible to verify and evaluate operation of the hardware of the fixing device 5 with high accuracy.

Although in the first embodiment, the operation of an actual device and that of a virtual device are combined, and in the second embodiment, the operation of an actual device and operation performed by the sequence software 155 implemented as jig software are combined, the present invention is not limited to these combinations.

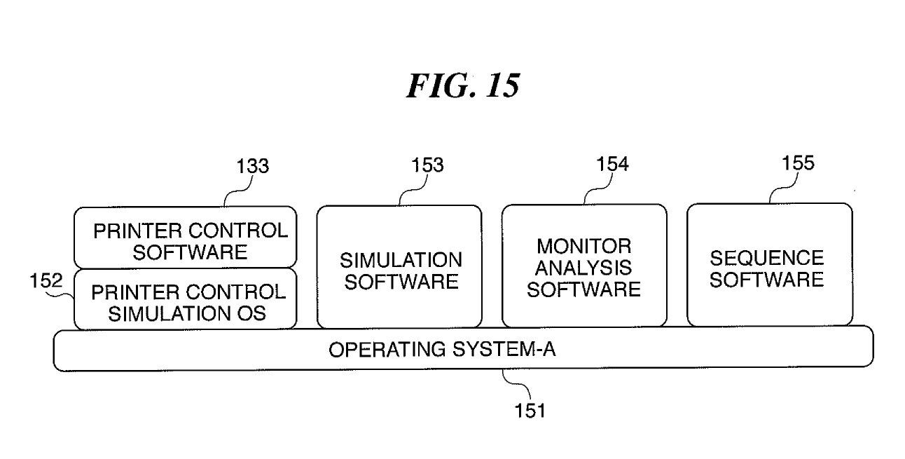

For example, when software configuration shown in FIG. 15 is employed, it is possible to simulatively realize printer operation by combining operation of an actual device, simulated operation of a virtual device, and operation performed by the jig software. In this case, it is possible to monitor the operation of the actual device by the monitor tool, the operation of the jig software while varying parameters thereof, and data from a jig operated by the jig software. This makes it possible to analyze information obtained through the monitor by the monitor analysis software 154, and carry out simulation while varying the settings of the simulation based on the results of the analyses.

It is to be understood that the object of the present invention may also be accomplished by supplying a system or an apparatus with a storage medium in which a program code of software, which realizes the functions of either of the above described embodiments is stored, and causing a computer (or CPU or MPU) of the system or apparatus to read out and execute the program code stored in the storage medium.

In this case, the program code itself read from the storage medium realizes the functions of either of the above described embodiments, and therefore the program code and the storage medium in which the program code is stored constitute the present invention.

Examples of the storage medium for supplying the program code include a floppy (registered trademark) disk, a hard disk, a magnetic-optical disk, a CD-ROM, a CD-R, a CD-RW, a DVD-ROM, a DVD-RAM, a DVD-RW, a DVD+RW, a magnetic tape, a nonvolatile memory card, and a ROM. Alternatively, the program may be downloaded via a network.

Further, it is to be understood that the functions of either of the above described embodiments may be accomplished not only by executing the program code read out by a computer, but also by causing an OS (operating system) or the like which operates on the computer to perform a part or all of the actual operations based on instructions of the program code.

Further, it is to be understood that the functions of either of the above described embodiments may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code

This application claims the benefit of Japanese Application No. 2005-376404, filed Dec. 27, 2005, which is hereby incorporated by reference herein in its entirety.

What is claimed is:

1. An image forming system comprising:
a plurality of operating units that perform operations for printing;
a plurality of printer driver units that drive said operating units, respectively;
a control unit connected to said printer driver units via a general-purpose bus interface to control said printer driver units;
a connection unit that connects an external computer to the image forming system via the general-purpose bus interface;
a printer control unit that constructs a printer control environment enabling control identical to the control by said control unit to be performed on said printer driver units, on the external computer, to thereby carry out printer control; and
a simulated printing operation-realizing unit that cooperates with said printer control unit to simulatively realize a printing operation.

2. An image forming system according to claim 1, wherein said simulated printing operation-realizing unit comprises:
a simulation unit that simulates an operation obtained by controlling a printer driver unit virtually implemented as a means substituted for a specific one of said printer driver units in the constructed printer control environment, the simulated operation being associated with an operation obtained by controlling the specific one of said printer driver units, and
a simulated operation-realizing unit that simulatively realizes a printing operation by combining the simulated operation and an operation obtained by controlling another one of said printer driver units different from the specific one in the constructed printer control environment.

3. An image forming system according to claim 1, wherein said simulated printing operation-realizing unit comprises:
a substitutive control unit that performs substitutive control of a specific one of said printer driver units in place of control thereof performed in the constructed printer control environment, and
a simulated operation-realizing unit that simulatively realizes a printing operation by combining an operation obtained by controlling the specific one of said printer driver units by the substitutive control and an operation obtained by controlling another one of said printer driver units different from the specific one in the constructed printer control environment.

4. An image forming system according to claim 1, wherein said simulated printing operation-realizing unit comprises:
a simulation unit that simulates an operation obtained by controlling a printer driver unit virtually implemented as a means substituted for a first one of said printer driver units in the constructed printer control environment, the simulated operation being associated with an operation obtained by controlling the first one of said printer driver units,
a substitutive control unit that performs substitutive control of a second one of said printer driver units in place of control thereof performed in the constructed printer control environment, and
a simulated operation-realizing unit that simulatively realizes a printing operation by combining the simulated operation, an operation obtained by controlling the second one of said printer driver units by the substitutive control, and an operation obtained by controlling another one of said printer driver units different from the first and second ones in the constructed printer control environment.

5. An image forming system according to claim 1, wherein the general-purpose bus interface is implemented by a PCI-EXPRESS bus.

6. A method of realizing a simulated printing operation for an image forming system including a plurality of operating units that perform operations for printing, a plurality of printer driver units that drive the operating units, respectively, and a control unit connected to the printer driver units via a general-purpose bus interface to control the printer driver units, comprising:
a connection step of connecting an external computer to the image forming system via the general-purpose bus interface;
a printer control step of constructing a printer control environment enabling control identical to the control by the control unit to be performed on the printer driver units, on the external computer, to thereby carry out printer control; and
a simulated printing operation-realizing step of cooperating with said printer control step to simulatively realize a printing operation.

7. A method according to claim 6, wherein said simulated printing operation-realizing step comprises:
a simulation step of simulating an operation obtained by controlling a printer driver unit virtually implemented as a means substituted for a specific one of the printer driver units in the constructed printer control environment, the simulated operation being associated with an operation obtained by controlling the specific one of said printer driver units, and
a simulated operation-realizing step of simulatively realizing a printing operation by combining the simulated operation and an operation obtained by controlling another one of the printer driver units different from the specific one in the constructed printer control environment.

8. A method according to claim 6, wherein said simulated printing operation-realizing step comprises:
a substitutive control step of performing substitutive control of a specific one of the printer driver units in place of control thereof performed in the constructed printer control environment, and
a simulated operation-realizing step of simulatively realizing a printing operation by combining an operation obtained by controlling the specific one of the printer driver units by the substitutive control and an operation obtained by controlling another one of the printer driver units different from the specific one in the constructed printer control environment.

9. A method according to claim 6, wherein said simulated printing operation-realizing step comprises:
a simulation step of simulating an operation obtained by controlling a printer driver unit virtually implemented as a means substituted for a first one of the printer driver units in the constructed printer control environment, the simulated operation being associated with an operation obtained by controlling the first one of said printer driver units,
a substitutive control step of performing substitutive control of a second one of the printer driver units in place of control thereof performed in the constructed printer control environment, and
a simulated operation-realizing step of simulatively realizing a printing operation by combining the simulated operation, an operation obtained by controlling the second one of the printer driver units by the substitutive control, and an operation obtained by controlling another one of printer driver units different from the first and second ones in the constructed printer control environment.

10. A program for causing an external computer to execute a method of realizing a simulated printing operation for an image forming system including a plurality of operating units that perform operations for printing, a plurality of printer driver units that drive the operating units, respectively, and a control unit connected to the printer driver units via a general-purpose bus interface to control the printer driver units, the program comprising:
a connection module for connecting the external computer to the image forming system via the general-purpose bus interface;
a printer control module for constructing a printer control environment enabling control identical to the control by the control unit to be performed on the printer driver units, on the external computer, to thereby carry out printer control; and
a simulated printing operation-realizing module for cooperating with said printer control module to simulatively realize a printing operation.

11. A program according to claim 10, wherein said simulated printing operation-realizing module comprises:
a simulation module for simulating an operation obtained by controlling a printer driver unit virtually implemented as a means substituted for a specific one of the printer driver units in the constructed printer control environment, the simulated operation being associated with an operation obtained by controlling the specific one of said printer driver units, and
a simulated operation-realizing module for simulatively realizing a printing operation by combining the simulated operation and an operation obtained by controlling another one of the printer driver units different from the specific one in the constructed printer control environment.

12. A program according to claim 10, wherein the simulated printing operation-realizing module comprises:
a substitutive control module for performing substitutive control of a specific one of the printer driver units in place of control thereof performed in the constructed printer control environment, and
a simulated operation-realizing module for simulatively realizing a printing operation by combining an operation obtained by controlling the specific one of the printer driver units by the substitutive control and an operation obtained by controlling another one of the printer driver units different from the specific one in the constructed printer control environment.

13. A program according to claim 10, wherein the simulated printing operation-realizing module comprises:
a simulation module for simulating an operation obtained by controlling a printer driver unit virtually implemented as a means substituted for a first one of the printer driver units in the constructed printer control environment, the simulated operation being associated with an operation obtained by controlling the first one of said printer driver units,
a substitutive control module for performing substitutive control of a second one of the printer driver units in place of control thereof performed in the constructed printer control environment, and
a simulated operation-realizing module for simulatively realizing a printing operation by combining the simulated operation, an operation obtained by controlling the second one of the printer driver units by the substitutive control, and an operation obtained by controlling another one of the printer driver units different from the first and second ones in the constructed printer control environment.

14. A storing medium storing the program according to claim 10 in a computer-readable manner.
